(19) United States
(12) Patent Application Publication
(10) Pub. No.: US 2004/0028430 A1
(43) Pub. Date: Feb. 12, 2004

(54) Electrophotographic printing device

(76) Inventors: Bernd Schultheis, Shwabenheim (DE); Birgit Lattermann, Ried-Stadt (DE); Dieter Jung, Daaden (DE)

Correspondence Address: Pauley Petersen Kinne & Erickson, 2800 West Higgins Road, Suite 365, Hoffman Estates, IL, 60195, US

(21) Appl. No.: 10/362,548

(22) PCT Filed: Oct. 6, 2001
(86) PCT No.: PCT/EP01/11540

(30) Foreign Application Priority Data
Oct. 20, 2000 (DE) 100 52 370.6

(51) Int. Cl. G03G 15/16

(52) U.S. Cl. 399/297; 399/310

(57) ABSTRACT

An electrophotographic printing device with a developer unit and a photoconductor. The photoconductor is either directly connected to a substrate to be printed in the region of a transfer zone, or is connected by an intermediate circuit of one or several transfer media. At least one charger is provided for the substrate and the substrate may be transported through the transfer zone by a transport device. According to this invention, an effective transfer of toner to the substrate surface can be achieved with such an arrangement, even with a poor electrically-conducting and thick-walled, sheet-like substrate, whereby a charger is arranged as the primary charger in the transport direction and a secondary charger is arranged in the region after the transfer zone and both primary and secondary chargers affect the surface of the substrate to be printed.

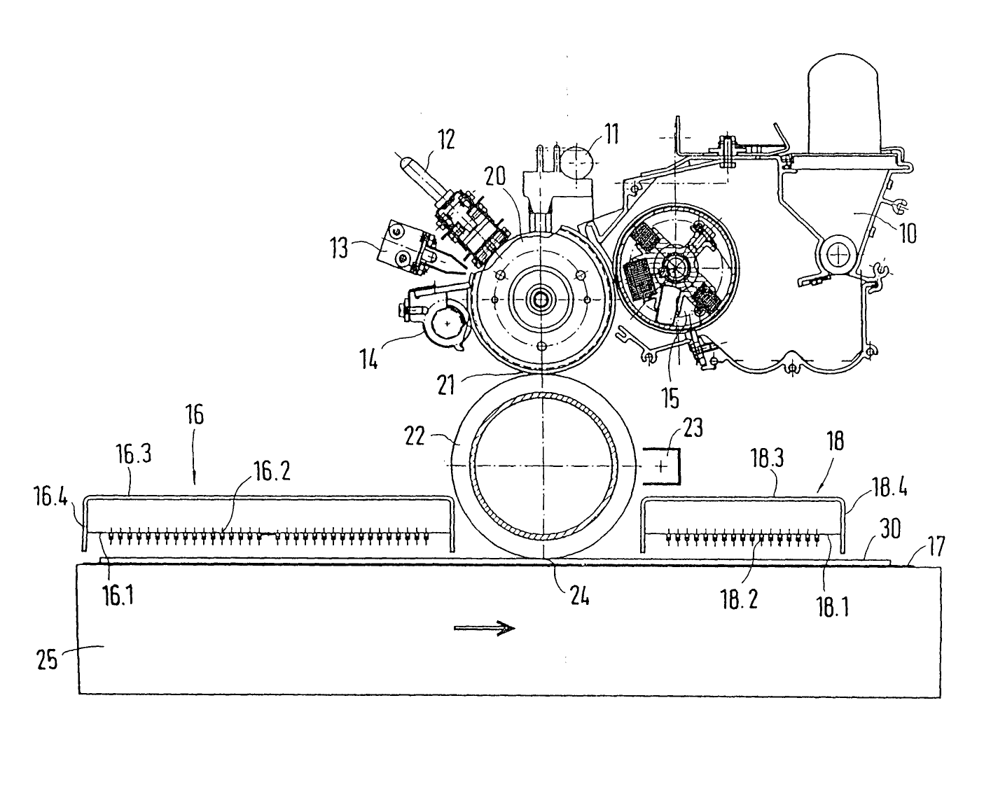

The invention relates to an electrophotographic printing device, having a developer unit and a photoconductor, wherein the photoconductor is connected directly or with the interposition of one or several transfer media with a substrate to be imprinted, located in a transfer zone, wherein at least one charging means is assigned to the substrate, and wherein the substrate can be conveyed through the transfer zone by means of a conveying device.

Such a printing device is known from DE 198 49 500 A1. There, a developer unit is used, in which a toner is stored. A photoconductor drum is assigned to the developer unit. The former can be activated on its surface by means of an exposure device, so that a toner application becomes possible. The photoconductor drum is in contact with a transfer roller via a contact line. The toner is transferred from the photoconductor drum to the transfer roller with the aid of coronas. The transfer roller rolls off on the surface of a substrate which is to be imprinted. In the process the toner is transferred to the substrate surface with the aid of a corona arranged on the underside of the substrate. Two transfer processes of the toner image take place with this arrangement. The first transfer process (TR1) occurs during the transfer from the photoconductor drum to the transfer roller, the second one (TR2) during the transfer of the toner to the substrate. No complete transfer of the toner takes place during each of the transfer processes. However, the attainment of the greatest possible transfer of the toner should be attempted, so that clear print images with sharp contours can be generated. In this connection the design and arrangement of the corona in the area of the transfer process TR2 is of importance. It is necessary to assure that the surface of the substrate to be imprinted is sufficiently electrostatically charged. With flat substrates of greater wall thickness in particular, insufficient charging occurs when the substrate consists of a material which does not conduct electricity well.

It is the object of the invention to produce an electrophotographic printing device of the type mentioned at the outset, by means of which an effective transfer of the toner to the substrate surface takes place, regardless of the thickness of the material of the substrate and its chemical properties.

This object is attained in that the charging means are arranged on the side facing the surface of the substrate to be imprinted and directly act on this surface to be imprinted.

A dependable charge is achieved because, in a reversal of the prior art, the charging means no longer act on the underside of the substrate, but directly on its surface to be coated. The charge can then be applied regardless of the consistency of the substrate.

In accordance with a preferred embodiment of the invention it is provided that one charging means, as the primary charging means, is arranged upstream of the transfer zone in the conveying direction, and a secondary charging means downstream of the transfer zone, and that the primary and secondary charging means act on the surface of the substrate to be imprinted.

With this arrangement, the substrate is first conducted to the primary charging means. Its surface to be imprinted can then be charged. Thereafter the substrate is conducted through the transfer zone. In the course of this, toner is applied to the surface to be imprinted. In the course of continued conveyance the substrate leaves the primary charging means. Depending on the size of the substrate and of the print image, it can occur in the course of this that the toner transfer to the substrate is not yet finished. In this case the secondary charging means prevents a drop in the charge by recharging the substrate. It is possible in this way to assure an even and effective transfer of the toner material throughout the entire coating process.

It is possible for the effects of the primary and/or secondary charging means to take place with or without contact here. For example, a charging brush can glide over the surface to be imprinted, or a charging roller can roll off on it. Particularly good charging results can be achieved in the course of the contactless charge method when using a primary, or a secondary charging corona. Charging spray heads with piezo-effect charging generators can also be employed as contactless charging means. In accordance with a preferred embodiment variation of the invention it is provided that the primary and/or secondary coronas are designed as flat coronas, which cover the entire width extending transversely in respect to the conveying direction of the surface of the substrate to be imprinted, and at least also partially over the surface in the conveying direction.

By means of this arrangement it is possible to charge large surfaces of the substrate, which makes a rapid charge application possible. In this way it is also possible to apply high substrate feeding speeds.

A possible variation of the invention can be such that the primary charging corona and/or the secondary charging corona have a corona wire holder in which several corona wires, which are arranged next to each other, are held under tension, and that the corona wires are connected to a uniform electrical potential. Because all corona wires are provided with a uniform electrical potential, it is possible to generate an even voltage image. In connection with this it can be provided in particular that the corona wire holders are installed in a housing and are electrically insulated against it, that the housing is connected with an electrical counter-potential, and that the housing shields the photoconductor and/or the transfer medium against the corona wires. The housing prevents the corona wires from affecting the charge image on the image drum, or on the transfer roller.

In accordance with a preferred embodiment variation of the invention it is provided that the corona wires are designed as individual wires, which have a spring element on one of their ends, by means of which the corona wire is suspended from a first corona wire holder, and that the other end of the corona wire is fastened on an oppositely located corona wire holder. By means of this it is possible to assure that all corona wires are uniformly suspended. It is prevented by this that their sagging extends in different lengths, which would generate a non-uniform charge image on the substrate surface.

However, it can also be provided that at least two of the corona wires which are arranged next to each other are formed by a continuous piece of wire, which is respectively reversed at the corona wire holders, and that the corona wires are uniformly prestressed.

For assuring a continuously uniform toner transfer it can be provided that the primary and the secondary charging coronas charge the substrate with a potential of the same sign, wherein the size of the potential on the surface of the substrate does not differ by more than 50% from the larger potential value.

A rapid surface charge can be achieved if the primary, as well as the secondary corona, are each assigned their own power supply unit. This can be further improved if it is provided that several power supply units, each of which supplies a group of corona wires with a voltage, are assigned to each of the primary and/or secondary coronas.

Typically the voltage potential lies between 1 and 10 kV. In this case it is particularly advantageous if it is provided that the voltage of the primary and the secondary coronas can be adjusted separately from each other.

To assure that in the course of passing through the transfer zone the substrate is always charged by at least one charging corona, it is provided that the distance of the primary charging corona from the secondary charging corona is less in the conveying direction than the extension in this direction of the surface of the substrate to be imprinted.

To prevent the substrate from being discharged via the conveying device it can be provided that the substrate is placed on the conveying device with the interposition of an insulator. The interposed layer consists of an insulated plastic material, which is highly resistant to disruptive discharge (for example polyimide, polyamide, epoxy resin, laminated paper, bakelite). Layers of a ceramic material (for example Al₂O₃) or thin glass are also conceivable.

The invention will be explained in greater detail in what follows by means of an exemplary embodiment represented in the drawings. The drawings represent in a lateral and sectional view a device for the electrostatic imprinting of substrates 30, in particular plate-shaped ones. The substrate 30 has been placed on a conveying device 25 with an insulator 17 interposed. For example, the conveying device 25 can be a linearly displaceable table or a conveyor belt. A primary charging corona 16 and a secondary charging corona 18 are assigned as charging means to the substrate 30. They provide the surface of the substrate 30 with a charge.

The primary and secondary charging coronas 16 and 18 are substantially similarly constructed, wherein the primary charging corona is of a larger size. The primary and secondary charging coronas 16 and 18 are designed as flat coronas. Each one has a corona wire holder 16.1, 18.1. The corona wire holder essentially has two combs, which extend parallel in respect to each other and between which the corona wires 16.2, 18.1 are suspended. In this case the ends of the corona wires 16.2, 18.2 are suspended on the teeth of the corona wire holders 16.1, 18.1. Each corona wire 16.2, 18.2 has a spring element at one of its ends. A loop is provided at the other end. The corona wires 16.2, 18.2 can be suspended by means of the loop from a comb of the corona wire holders 16.1, 18.1. The end of the corona wires 16.2, 18.2 having a spring element can be suspended from the oppositely located comb. In the process a tension of the corona wires 16.2, 18.2 in the corona wire holders 16.1, 18.1 is achieved by means of the spring element. Since an identical spring element is assigned to each corona wire 16.2, 18.2, the tensile stress in each one of the individual corona wires 16.2, 18.2 is identical. It is achieved by means of this that the corona wires 16.2, 18.2 are uniformly tightly stretched. As can be seen in the drawings, the primary charging corona 16 is divided at the center of the corona wire holders 16.1, 18.1. An insulation is provided here. In this way two sections of corona wires 16.2, 18.2 are formed. A power supply unit is assigned to each one of these sections, which supplies the corona wires 16.2, 18.2 with electrical current. A power supply unit is also assigned to the secondary charging corona 18. The corona wire holder 16.1, 8.1 has been placed into a housing 16.3, 18.3. The housing 16.3, 18.3 has a cover section, around which a lateral wall 16.4 is placed, which protrudes in the direction toward the substrate 30.

The primary and the secondary charging coronas 16 and 18 are arranged opposite the substrate surface 30 to be imprinted. In this way they can act directly on the surface of the substrate 30. A transfer medium 22 of an electrophotographic unit is arranged in the area between the primary and the secondary charging coronas 16 and 18. In the present exemplary embodiment, the transfer medium 22 is embodied as a cylinder body. However, it can also be designed as an endlessly rotating belt. The transfer medium 22 is in contact with the substrate 30 in the area of a contact zone 24. A charging corona 23 is arranged in the transfer medium 22. The former charges the surface of the transfer medium 22, wherein the charge has a polarity opposite to the charge of the substrate.

However, with an appropriate design of the photoconductor 20, the transfer medium 22 can be omitted.

The electrophotographic unit also has a developer unit 10, which is constructed in a known manner. A toner, for example a ceramic toner or a thermoplastic or duromeric plastic toner, is stored in the developer unit 10. The developer unit 10 has a developer drum 15, by means of which the toner is conducted to a photoconductor 20. The photoconductor 20 is embodied to be cylinder-shaped and is in a linear engagement with the transfer medium 22 in a contact zone 21.

An exposure device 11 is provided above the photoconductor 20, which exposes a photosensitive layer of the photoconductor in a known manner. A latent electrostatic charge image is created by this. Because of this charge image it is possible to apply toner particles from the developer drum 15 to the outer conductor layer of the photoconductor 20 by means of electrostatic actions. The toner particles are transferred to the transfer medium 22 in the area of the contact zone 21. Toner remnants, which possibly still adhere to the photoconductor 20, are removed by a cleaning unit 14, which follows the contact zone 21. A discharge light following the cleaning unit 14 discharges the photosensitive coating of the photoconductor. Then this photosensitive layer is returned to a uniform charge structure by means of a charging corona 12, so that it can again be provided with an electrostatic charge image by the exposure device 11. In the course of the printing operation the substrate 30 is evenly linearly displaced by means of the conveying device 25. In the process, the transfer medium 22 rolls off either passively or in a driven manner on the surface of the substrate 30 to be imprinted. In the course of this the toner on the transfer medium 22 is transferred to the substrate 30 in the transfer zone 24. This transfer takes place in particular because the primary and the secondary charging coronas cause the charging of the entire surface of the substrate surface. As already mentioned above, this charge is polarized opposite to the charge on the transfer medium 22, so that a dependable toner transfer of high effectiveness can take place.

As can be seen in the drawing, the distance in the conveying direction between the primary and the secondary charging coronas 16 and 18 has been selected to be less than the extent of the substrate in this direction. In this way it is assured that the substrate 30 is being continuously charged during its entire passage through the transfer zone 24. When the substrate leaves the charging area of the primary corona 16, it is in any case in contact with the charging area of the secondary charging corona 18.

Some examples will be shown in what follows, which describe the preferred applications of the above described device in greater detail:

1. Imprinting of plate-shaped glass, glass-ceramic or ceramic materials with ceramic toners for decorating purposes. Following imprinting, as a rule the toner is pre-fixed and is subsequently fired at temperatures between 500 and 1000° Celsius. Examples of use are: decorated glass-ceramic cooktops, decorated glass-ceramic layered stove tiles, decorated glass products, such as stove front plates, control panels, glass for shower enclosures, signs made of glass, glass doors, glass tiles, glass in furniture, decorated ceramic articles, such as tiles, etc.

2. Imprinting of plate-shaped plastic materials, or glass or glass-ceramic materials with thermoplastic and/or thermoset plastic toners for decorative purposes. Following imprinting, as a rule the toner is pre-fixed and is subsequently fired at temperatures between 120 and 200° Celsius, preferably 150 to 180° Celsius. Examples of use are: decorated plastic surfaces made of thermoplastic or thermoset plastic materials such as, for example, plastic surfaces in the field of furniture or small household devices, tabletops, front panels, or glass materials such as, for example, signs.

3. Imprinting of glass, glass-ceramic or plastic surfaces for a specific modification of the surface properties, for example for imprinting electrically conductive surfaces, for surface hardening, or the like. As a rule this is also followed by heating processes for firing, tempering, or the like.

It is possible by means of this arrangement to effectively imprint plate-shaped materials in particular. Slight unevenesses of the substrate surface as a result of processing are compensated by the arrangement in accordance with the invention. For compensating surface uneveness it is also possible to provide the transfer medium with a flexible coating placed on the surface of the substrate. The surface of the photoconductor 20 can be provided with a flexible coating in the same way. In that case the photoconductor 20 can be placed directly on the surface of the substrate 23 without using a transfer medium 22.

By means of charging from the side to be imprinted it is achieved that a toner transfer takes place independently to a large extent of the substrate material and of the substrate thickness. It is then possible, if desired, to provide an individual adaptation to the substrate material and to the material thickness by adapting the corona voltage.

1. An electrophotographic printing device, having a developer unit and a photoconductor, wherein the photoconductor is connected directly or with the interposition of one or several transfer media with a substrate to be imprinted, located in a transfer zone, wherein at least one charging means is assigned to the substrate, and wherein the substrate can be conveyed through the transfer zone by means of a conveying device, characterized in that
the charging means are arranged on the side facing the surface of the substrate (30) to be imprinted and directly acts on this surface to be imprinted.

2. The electrophotographic printing device in accordance with claim 1, characterized in that
one charging means, as the primary charging means, is arranged upstream of the transfer zone in the conveying direction, and a secondary charging means downstream of the transfer zone, and
the primary and secondary charging means act on the surface of the substrate (30) to be imprinted.

3. The electrophotographic printing device in accordance with claim 2, characterized in that
the primary and/or the secondary charging means are constituted by a primary/secondary charging corona (16, 18), a primary/secondary charging brush, a primary/secondary charging spray head(s), the one primary/secondary charging roller.

4. The electrophotographic printing device in accordance with one of claims 1 to 3, characterized in that
the primary and/or secondary coronas (16 and 18) are designed as flat coronas, which cover the entire width extending transversely in respect to the conveying direction of the surface of the substrate (30) to be imprinted, and at least partially over the surface in the conveying direction.

5. The electrophotographic printing device in accordance with one of claims 3 or 4, characterized in that
the primary charging corona (16) and/or the secondary charging corona (18) have a corona wire holder (16.1, 18.1) in which several corona wires (16.2, 18.2), which are arranged next to each other, are held under tension, and
the corona wires (16.2, 18.2) are connected with a uniform electrical potential.

6. The electrophotographic printing device in accordance with claim 3, characterized in that
the corona wire holders are installed in a housing (16.3, 18.3) and are electrically insulated against it,
the housing (16.3, 18.3) is connected with an electrical counter-potential, and
the housing (15.3, 18.3) shields the photoconductor (20) and/or the transfer medium against the corona wires (16.2, 18.2).

7. The electrophotographic printing device in accordance with claim 5 or 6, characterized in that
the corona wires (16.2, 18.2) are designed as individual wires, which have a spring element on one of their ends, by means of which the corona wire (16.2, 18.2) is suspended from a first corona wire holder (16.1, 18.1), and
the other end of the corona wire (16.2, 18.2) is fastened on an oppositely located corona wire holder (16.1, 18.1).

8. The electrophotographic printing device in accordance with claim 5 or 6, characterized in that
at least two of the corona wires (16.2, 18.2) which are arranged next to each other are formed by a continuous piece of wire, which is respectively reversed at the corona wire holders (16.1, 18.2), and
the corona wires (16.2, 18.2) are uniformly prestressed.

9. The electrophotographic printing device in accordance with one of claims 1 to 8, characterized in that
the primary and the secondary charging coronas (16 and 18) charge the substrate (30) with a potential of the same sign, wherein the size of the potential on the surface of the substrate (30) does not differ by more than 50% from the larger potential value.

10. The electrophotographic printing device in accordance with one of claims 1 to 9, characterized in that
for current supply, the primary, as well as the secondary coronas (16 and 18) are each assigned their own power supply unit.

11. The electrophotographic printing device in accordance with one of claims 1 to 10, characterized in that
the primary and/or secondary coronas (16, 18) are each assigned several power supply units, each of which supplies a group of corona wires with a voltage.

12. The electrophotographic printing device in accordance with one of claims 2 to 11, characterized in that
the voltage of the primary and the secondary coronas can be adjusted separately from each other.

13. The electrophotographic printing device in accordance with one of claims 1 to 12, characterized in that
the distance of the primary charging corona (16) from the secondary charging corona is less in the conveying direction than the extension in this direction of the surface of the substrate (30) to be imprinted.

14. The electrophotographic printing device in accordance with one of claim 1 to 13, characterized in that
the substrate (30) is placed on the conveying device (25) with the interposition of an insulator (17).

15. The electrophotographic printing device in accordance with claim 14, characterized in that
the insulator (17) is made of a highly insulating plastic material, which is highly resistant to disruptive discharge.

16. The electrophotographic printing device in accordance with claim 14 or 15, characterized in that
the insulator (17) is made of an abrasion-resistant and mechanically stressable ceramic or silicate material, for example Al₂O₃ or glass.
